(19) United States
(12) Patent Application Publication
(10) Pub. No.: US 2017/0106716 A1
(43) Pub. Date: Apr. 20, 2017

(54) AIR CONDITIONING DEVICE FOR VEHICLE

(71) Applicant: DENSO CORPORATION, Kariya-city, Aichi-pref. (JP)

(72) Inventors: Shinichiro HIRAI, Kariya-city (JP); Akira INUKAI, Kariya-city (JP)

(21) Appl. No.: 15/300,547

(22) PCT Filed: Mar. 30, 2015
(86) PCT No.: PCT/JP2015/001829

§ 371 Date: Sep. 29, 2016

(30) Foreign Application Priority Data
Apr. 1, 2014 (JP) 2014-075421
Mar. 3, 2015 (JP) 2015-041660

(51) Int. Cl. B60H 1/00

(52) U.S. Cl. CPC B60H 1/00028; B60H 1/00842; B60H 2001/00135; B60H 2001/00092

(57) ABSTRACT

An air conditioning device has an electric blower, an air conditioning case, a cooling heat exchanger, and a partition wall. The electric blower has an electric motor, a fan, and a blowing case. Air from the blowing case flows toward the vehicle interior through the air conditioning case. The cooling heat exchanger is disposed in the air conditioning case. The partition wall is disposed on an upstream side of the cooling heat exchanger in the air conditioning case and partitions an inside of the air conditioning case into a first ventilation path and a second ventilation path. The blowing case is connected to a portion of the air conditioning case located on the upstream side of the cooling heat exchanger. The portion of the air conditioning case supports the partition wall formed along a flow direction of a main flow of the air blowing from the blowing case.

### CROSS REFERENCE TO RELATED APPLICATION

This application is based on Japanese Patent Application No. 2014-075421 filed on Apr. 1, 2014 and Japanese Patent Application No. 2015-041660 filed on Mar. 3, 2015, the disclosures of which are incorporated herein by reference.

### TECHNICAL FIELD

The present disclosure relates to an air conditioning device for a vehicle.

### BACKGROUND ART

Conventionally, an interior air conditioning unit of an air conditioning device for a vehicle is provided with an air conditioning case (hereafter referred to as “airflow adjustment case portion”) for straightening a flow of air on an upstream side of an evaporator in a flow direction of air so that a wind speed distribution of the airflow blowing from an electric blower to the evaporator becomes uniform (refer to Patent Literature 1, for example).

The airflow adjustment case portion has such a stepped shape that gradually throttles the flow of air from the blower from the upstream side toward a downstream side such that the wind speed distribution becomes uniform. In general, unnecessary reinforcing ribs and the like are not provided inside the air conditioning case to prevent a generation of turbulence of the airflow.

As an air conditioning device for a vehicle in recent years, an interior air conditioning unit through which an inside-outside air two-layer flow flows (hereafter referred to as “inside air/outside air two-layer-flow interior air conditioning unit) has been developed as in Patent Literature 2, for example.

The inside air/outside air two-layer-flow interior air conditioning unit includes an upper-layer air passage for taking in outside air as dehumidifying air from a blower and a lower-layer air passage for taking in warm air from a vehicle interior. The dehumidifying air taken in from the upper-layer air passage can be blown out onto a windshield through a defroster and the warm air taken in from the vehicle interior through the lower-layer air passage can be supplied to foot of an occupant.

In the inside air/outside air two-layer-flow interior air conditioning unit, the upper-layer air passage and the lower-layer air passage are separated from each other by a partition wall from the electric blower to a heater unit in an air conditioning casing so that the dehumidifying air in the upper-layer air passage and the warm air in the lower-layer air passage are not mixed with each other. Moreover, the above-mentioned airflow adjustment case portion includes a partition wall.

### PRIOR ART LITERATURES

### Patent Literature

Patent Literature 1: JP 2006-232208 A

Patent Literature 2: JP H09-156348 A

### SUMMARY OF INVENTION

Based on Patent Literatures 1 and 2, the inventors of the present disclosure conducted studies on a rigidity of a single-layer-flow interior air conditioning unit, instead of the inside air/outside air two-layer-flow interior air conditioning unit, that takes in at least one of inside air and outside air from an electric blower for a single layer flow and introduces the air to a side of an evaporator as a single layer flow.

According to the studies by the inventors of the present disclosure, the unnecessary reinforcing ribs are not provided inside the airflow adjustment case portion in order to avoid turbulence of the airflow, and thereby a rigidity of the airflow adjustment case portion is small. Therefore, vibrations from an electric motor of the electric blower may be transmitted to the airflow adjustment case portion, and the airflow adjustment case portion may vibrate and resonate with the vibrations. In this case, the airflow adjustment case portion may amplify the vibrations and become a generation source of abnormal noise.

In a view of the above-described point, an object of the present disclosure is to provide an air conditioning device for a vehicle capable of suppressing resonance of an air conditioning case due to sound transmitted from the electric blower for a single layer flow when introducing air taken in from the electric blower toward a cooling heat exchanger.

The present disclosure has been made by focusing on the fact that the inside air/outside air two-layer-flow interior air conditioning unit is provided with the partition wall for separating the upper-layer air passage and the lower-layer air passage from each other.

According to a first aspect of the present disclosure, an air conditioning device for a vehicle has an electric blower for a single layer flow, an air conditioning case, a cooling heat exchanger, and a partition wall. The electric blower has (i) an electric motor, (ii) a fan that is driven by the electric motor and introduces at least one of air outside a vehicle interior and air inside the vehicle interior, and (iii) a blowing case that forms a single layer air passage in which the air outside the vehicle interior and the air inside the vehicle interior blowing from the fan flow without being separated from each other. Air blowing from the blowing case flows toward the vehicle interior through the air conditioning case. The cooling heat exchanger is disposed in the air conditioning case and cools the air blowing from the blowing case. The partition wall is disposed on an upstream side of the cooling heat exchanger in a flow direction of the air in the air conditioning case and partitions an inside of the air conditioning case into a first ventilation path and a second ventilation path.

The air blowing from the blowing case flows through the first ventilation path and the second ventilation path. The blowing case is connected to a portion of the air conditioning case located on the upstream side of the cooling heat exchanger in the flow direction of the air. The partition wall is supported by the portion of the air conditioning case located on the upstream side of the cooling heat exchanger in the flow direction of the air, and formed along a flow direction of a main flow of the air blowing from the blowing case.

The portion of the air conditioning case located on the upstream side of the cooling heat exchanger in the flow direction of the air supports the partition wall. As a result, a displacement of the portion of the air conditioning case supporting the partition wall is suppressed, and a rigidity of the portion of the air conditioning case located on the upstream side of the cooling heat exchanger in the flow direction of the air can be increased, when the air conditioning case generates vibrations. Therefore, resonance of the portion of the air conditioning case located on the upstream side of the cooling heat exchanger in the flow direction of the air can be prevented from being caused by vibrations transmitted from the electric motor.

The main flow is a flow having a largest volume of air among flows of air blowing from the electric blower toward the cooling heat exchanger.

According to a second aspect of the present disclosure, an air conditioning device for a vehicle may have partition walls that are disposed not to overlap with each other when viewed in the flow direction of the air.

In this case, the air conditioning case supports the partition walls. Therefore, rigidity of the air conditioning case can be further increased.

According to a third aspect of the present disclosure, an air conditioning device for a vehicle may have a partition wall that is configured by plate members. Each of the plate members is formed to have a plate shape extending along the flow direction of the main flow. The plate members are disposed to be distanced from each other and arranged in the flow direction of the air.

As a result, the air flows between the first and second ventilation paths through a space between adjacent two of the plate members. Therefore, a distribution of the air flowing into the cooling heat exchanger can be further uniform in a direction in which the first and second ventilation paths are arranged.

### BRIEF DESCRIPTION OF DRAWINGS

FIG. 1 is a schematic diagram illustrating an inside of an interior air conditioning unit of an air conditioning device for a vehicle according to a first embodiment of the present disclosure.

FIG. 2 is a schematic diagram illustrating an inside of an airflow adjustment case portion in FIG. 1.

FIG. 3 shows graphs showing a result of a verification experiment of a vibration acceleration of the air conditioning device for a vehicle in FIG. 1.

FIG. 4 shows graphs showing a result of a verification experiment of a noise level of the air conditioning device for a vehicle in FIG. 1.

FIG. 5 is a schematic diagram illustrating an inside of an inside air/outside air two-layer-flow interior air conditioning unit which is a comparative example of the present disclosure.

FIG. 6 is a schematic diagram illustrating an inside of an interior air conditioning unit according to a first variation of the first embodiment.

FIG. 7 is a schematic diagram illustrating the inside of the airflow adjustment case portion according to a second variation of the first embodiment.

FIG. 8 is a schematic diagram illustrating a flow of air in the airflow adjustment case portion according to the second variation of the first embodiment.

FIG. 9 is a schematic diagram illustrating an inside of an airflow adjustment case portion according to a second embodiment of the present disclosure.

FIG. 10 is a schematic diagram illustrating the inside of the airflow adjustment case portion according to a first variation of the second embodiment.

FIG. 11 is a schematic diagram illustrating an inside of an airflow adjustment case portion according to a third embodiment of the present disclosure.

FIG. 12 is a sectional view perpendicular to a flow direction of a main flow of air in the airflow adjustment case portion in FIG. 11.

FIG. 13 is a sectional view perpendicular to a flow direction of a main flow of air in an airflow adjustment case portion according to a first variation of the third embodiment.

FIG. 14 is a sectional view perpendicular to a flow direction of a main flow of air in the airflow adjustment case portion according to a second variation of the third embodiment.

FIG. 15 is a schematic diagram illustrating an inside of the airflow adjustment case portion according to a third variation of the third embodiment.

FIG. 16 is a sectional view perpendicular to a flow direction of a main flow of air in FIG. 15.

FIG. 17 is a schematic diagram illustrating the inside of the airflow adjustment case portion according to a fourth variation of the third embodiment.

FIG. 18 is a view taken in a direction of arrow A in FIG. 17.

FIG. 19 is a schematic diagram illustrating an inside of an airflow adjustment case portion according to a fourth embodiment of the present disclosure.

FIG. 20 is a sectional view perpendicular to a flow direction of a main flow of air in the airflow adjustment case portion in FIG. 19.

FIG. 21 is a schematic diagram illustrating the inside of the airflow adjustment case portion of an air conditioning device for a vehicle according to a first variation of the fourth embodiment of the present disclosure.

FIG. 22 is a view taken in a direction of arrow A in FIG. 21.

### DESCRIPTION OF EMBODIMENTS

Embodiments of the present disclosure will be described hereafter referring to drawings. In the embodiments, a part that corresponds to or equivalents to a matter described in a preceding embodiment may be assigned with the same reference number to simplify the description.

### First Embodiment

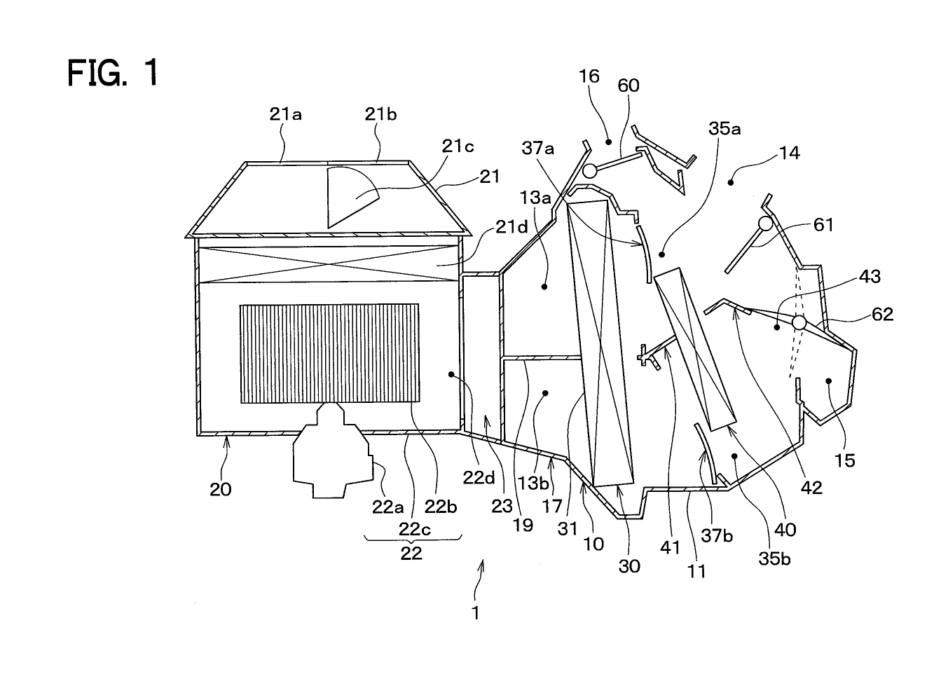

An air conditioning device 1 for a vehicle includes an interior air conditioning unit 10 and a blower unit 20 as shown in FIG. 1.

The interior air conditioning unit 10 is a single-layer-flow interior air conditioning unit that is arranged in a lower portion of a dashboard (i.e., an instrument panel) on a side adjacent to a center in a vehicle interior. The blower unit 20 is disposed at a position displaced from the interior air conditioning unit 10 toward a passenger seat.

The blower unit 20 is a single-layer-flow blower unit configured by an inside/outside air introduction switching box 21 and an electric blower 22 for a single layer flow. The inside/outside air introduction switching box 21 is provided with an outside air introducing port 21b for introducing air outside the vehicle interior (i.e., outside air) and an inside air introducing port 21a for introducing air inside the vehicle interior (i.e., inside air). In the inside/outside air introduction switching box 21, an inside/outside air switching door 21c and a filter 21d are disposed. The inside/outside air switching door 21c is driven by an actuator such as a servomotor to open one of the outside air introducing port 21b and the inside air introducing port 21a. The filter 21d filters the air introduced from one of the outside air introducing port 21b and the inside air introducing port 21a.

The electric blower 22 includes a direct-current motor (i.e., an electric motor) 22a, a single fan 22b, and a scroll casing 22c. The direct-current motor 22a is supported by the scroll casing 22c to drive the fan 22b rotatably. The fan 22b is driven by the direct-current motor 22a, draws the air introduced from at least one of the outside air introducing port 21b and the inside air introducing port 21a through the filter 21d, and blows out the air.

As the single fan 22b of the present embodiment, a centrifugal fan that draws the air from one side in an axial direction of a rotating shaft of the direct-current motor 22a and blows the air outward in a radial direction of the rotating shaft is used. The direct-current motor 22a is a known motor having a rotor supported on the rotating shaft and a stator supported by a motor case that are housed in the motor case. The scroll casing 22c houses the fan 22b and has a single layer air passage for collecting the air blowing from the fan 22b and allowing the air to flow toward a blow outlet 22d. The single layer air passage is an air passage through which the outside air and the inside air blowing from the fan 22b flow without being separated from each other.

The interior air conditioning unit 10 is a single-layer-flow interior air conditioning unit including an air conditioning case 11 having an air passage through which the air blowing from the blower unit 20 flows toward the vehicle interior. The air conditioning case 11 has a suction port 13, a face opening portion 14, a foot opening portion 15, and a defroster opening portion 16. The suction port 13 is provided to a case portion of the air conditioning case 11 positioned on an upstream side of a cooling heat exchanger 30 in a flow direction of air. The case portion is hereafter referred to as “airflow adjustment case portion 17”. The blow outlet 22d of the scroll casing 22c is connected to the suction port 13 via a duct 23. The air blowing from the scroll casing 22c is drawn into the suction port 13 via the duct 23.

An inlet forming portion of the duct 23 forming an air inlet is connected to an outlet forming portion of the scroll casing 22c by a method such as screwing. The outlet forming portion forms an air outlet of the scroll casing 22c for blowing out the air.

The air conditioning case 11 of the present embodiment is configured by coupling divided case portions. The airflow adjustment case portion 17 configures one of the divided case portions. A specific structure of the airflow adjustment case portion 17 will be described later.

Here, the face opening portion 14 is an opening portion that guides a conditioned air to a face blow outlet. The face blow outlet is a blow outlet that blows the conditioned air to an upper body of the occupant in the vehicle interior. The foot opening portion 15 is an opening portion that guides the conditioned air to a foot blow outlet. The foot blow outlet is a blow outlet that blows the conditioned air to a lower body of the occupant in the vehicle interior. The defroster opening portion 16 is an opening portion that guides the conditioned air to a defroster blow outlet. The defroster blow outlet is a blow outlet that blows the conditioned air to an inner surface of a windshield.

The cooling heat exchanger 30, a heating heat exchanger 40, and mode doors 60, 61, 62 are disposed in the air conditioning case 11.

The cooling heat exchanger 30 configures a refrigeration cycle for circulating a refrigerant together with a compressor, a condenser, a pressure reducing valve, and the like and cools the air introduced from the suction port 13 using the refrigerant. The cooling heat exchanger 30 is configured by first and second tanks, tubes, and heat exchange fins and has a flattened shape. The cooling heat exchanger 30 is disposed in a standing state. A flattened direction of the cooling heat exchanger 30 is parallel to a vehicle width direction (i.e., a left-right direction of a vehicle). The flattened direction is a direction which is perpendicular to a thickness direction and in which the cooling heat exchanger 30 extends.

The heating heat exchanger 40 is disposed on a downstream side of the cooling heat exchanger 30 in a flow direction of air and heats the air passing through the cooling heat exchanger 30 using engine cooling water (i.e., warm water). The cooling heat exchanger 30 and the heating heat exchanger 40 are supported by the air conditioning case 11.

Bypass passages 35a, 35b are provided in the air conditioning case 11 and guides cold air flowing from the cooling heat exchanger 30 to bypass the heating heat exchanger 40 and flow to each of the blow opening portions. The bypass passage 35a is located above the heating heat exchanger 40 in the air conditioning case 11. The bypass passage 35b is located below the heating heat exchanger 40 in the air conditioning case 11.

Air mix doors 37a and 37b are provided between the heating heat exchanger 40 and the cooling heat exchanger 30. The air mix door 37a changes a ratio between an amount of air passing through the bypass passage 35a and an amount of air passing through the heating heat exchanger 40. The air mix door 37b changes a ratio between an amount of air passing through the bypass passage 35b and an amount of air passing through the heating heat exchanger 40. By the air mix doors 37a, 37b actuated in this manner, a temperature of air blown into the vehicle interior through the opening portions 14, 15, 16 can be changed. The opening portions 14, 15, 16 are generic names for the face opening portion 14, the foot opening portion 15, and the defroster opening portion 16.

Partition walls 41, 42 are provided in the air conditioning case 11. The partition wall 41 partitions the air passage in the air conditioning case 11 between the heating heat exchanger 40 and the cooling heat exchanger 30 into an upper ventilation path (i.e., a first ventilation path) 13a and a lower ventilation path (i.e., a second ventilation path) 13b (see FIG. 1). The partition wall 42 partitions a portion in the air conditioning case 11 on a downstream side of the heating heat exchanger 40 into the upper ventilation path 13a and the lower ventilation path 13b. An opening portion 43 through which the upper ventilation path 13a and the lower ventilation path 13b communicate with each other is formed on a downstream side of the partition wall 42 in the air conditioning case 11.

The mode door 60 is supported by the air conditioning case 11 to open or close the defroster opening portion 16. The mode door 61 is supported by the air conditioning case 11 to open or close the face opening portion 14. The mode door 62 is supported by the air conditioning case 11 to open one of the foot opening portion 15 and the opening portion 43 and close the other opening portion.

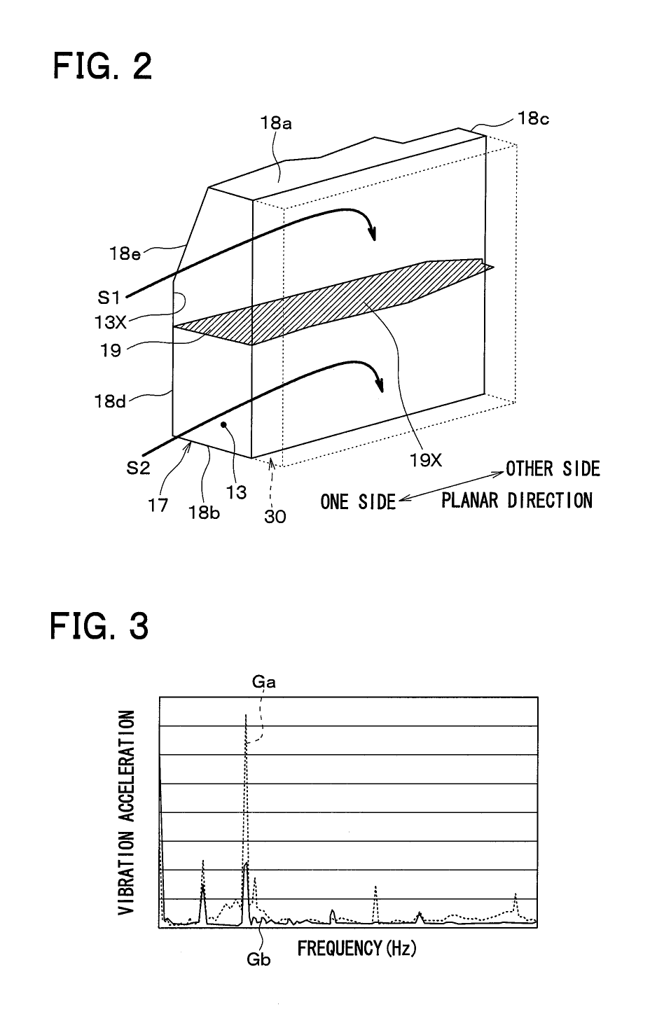

Next, details of the airflow adjustment case portion 17 of the present embodiment will be described with reference to FIG. 2.

The airflow adjustment case portion 17 forms an upstream case portion of the air conditioning case 11 extending from a connection portion 13X (see FIG. 2) to which the duct 23 is connected to the cooling heat exchanger 30. The connection portion 13X is a suction port forming portion of the air conditioning case 11 forming the suction port 13. An outlet forming portion of the duct 23 is connected to the suction port forming portion by a fastening member such as a screw. The outlet forming portion is a portion of the duct 23 forming an outlet for blowing out the air. The duct 23 configures a blowing case of the present disclosure together with the scroll casing 22c. The suction port forming portion is configured by an upper wall 18a, a lower wall 18b, and opposed walls 18d, 18e described later.

Specifically, the airflow adjustment case portion 17 includes the upper wall 18a, the lower wall 18b, a sidewall 18c, and the opposed walls 18d, 18e. The upper wall 18a is positioned forward of the cooling heat exchanger 30 in a front-rear direction of the vehicle. The upper wall 18a is disposed above the sidewall 18c, the opposed walls 18d, 18e, and the cooling heat exchanger 30 in a vertical direction.

The lower wall 18b is disposed forward of the cooling heat exchanger 30. The lower wall 18b is disposed below the sidewall 18c, the opposed walls 18d, 18e, and the cooling heat exchanger 30 in the vertical direction.

The opposed walls 18d, 18e are opposed to an air inflow surface 31 of the cooling heat exchanger 30. In other words, the opposed walls 18d, 18e are positioned in normal directions to the air inflow surface 31. The air inflow surface 31 is a surface of the cooling heat exchanger 30 into which the air after passing through the upper ventilation path 13a and the air after passing through the lower ventilation path 13b flow. The opposed walls 18d, 18e of the present embodiment are positioned forward of the air inflow surface 31. The opposed wall 18d is formed in a stepped shape so as to approach the air inflow surface 31 from the upstream side toward the downstream side of the flow of the air. The opposed wall 18e positioned above the opposed wall 18d is inclined to approach the air inflow surface 31 toward the upper side in the vertical direction.

The suction port 13 is formed by the upper wall 18a, the lower wall 18b, the opposed walls 18d, 18e, and the like and is open on one side (passenger seat side) in the vehicle width direction. In other words, the suction port 13 is open on one side in a planar direction of the air inflow surface 31 of the cooling heat exchanger 30 (see FIG. 2). In other words, the suction port forming portion is disposed on one side of the air inflow surface 31 of the cooling heat exchanger 30 in the planar direction.

The planar direction of the air inflow surface 31 is a direction in which the air inflow surface 31 extends. The sidewall 18c is disposed forward of the cooling heat exchanger 30 and on the other side in the vehicle width direction. In other words, the sidewall 18c is disposed on an opposite side from the suction port 13 (i.e., the suction port forming portion) with respect to the air inflow surface 31.

A partition wall 19 is provided in the airflow adjustment case portion 17 according to the present embodiment. The partition wall 19 is configured to have a plate shape extending along a flow direction (see arrows S1, S2 in FIG. 2) of a main flow of the air blowing from the blower unit 20. In other words, the partition wall 19 is disposed parallel to a flow direction of the main flow. The main flow is a flow having a largest volume among flows of air blowing from the blower unit 20 toward the cooling heat exchanger 30.

The partition wall 19 is supported by the sidewall 18c and the opposed wall 18d. The partition wall 19 is disposed parallel to a horizontal direction so as to partition an inside of the airflow adjustment case portion 17 into the upper ventilation path 13a and the lower ventilation path 13b. Therefore, the partition wall 19 is formed along the flow direction of the main flow of the air blowing from the blower unit 20.

Next, an operation of the air conditioning device 1 for a vehicle according to the present embodiment will be described.

The direct-current motor 22a rotates the fan 22b in the electric blower 22 of the blower unit 20. The inside/outside air switching door 21c opens one of the outside air introducing port 21b and the inside air introducing port 21a. Therefore, the fan 22b takes in the air from at least one of the outside air introducing port 21b and the inside air introducing port 21a and blows out the air from the blow outlet 22d.

The air blowing from the blow outlet 22d flows into the airflow adjustment case portion 17 via the scroll casing 22c, the duct 23, and the suction port 13. The air flowing in this manner is divided into the upper ventilation path 13a and the lower ventilation path 13b on the opposite sides of the partition wall 19.

For example, the fan 22b introduces the inside air through the inside air introducing port 21a and blows out the inside air when the inside/outside air switching door 21c closes the outside air introducing port 21b and opens the inside air introducing port 21a. Therefore, the inside air blown by the fan 22b flows through the upper ventilation path 13a and the lower ventilation path 13b via the scroll casing 22c, the duct 23, and the suction port 13.

On the other hand, the fan 22b introduces the outside air through the outside air introducing port 21b and blows out the outside air when the inside/outside air switching door 21c opens the outside air introducing port 21b and closes the inside air introducing port 21a. Therefore, the outside air blown by the fan 22b flows into the upper ventilation path 13a and the lower ventilation path 13b via the scroll casing 22c, the duct 23, and the suction port 13.

The fan 22b introduces the outside air through the outside air introducing port 21b and the inside air through the inside air introducing port 21a, and blows out the outside air and inside air, when the inside/outside air switching door 21c opens the outside air introducing port 21b and the inside air introducing port 21a. The outside air and the inside air blown by the fan 22b flow through the scroll casing 22c and the duct 23 without being separated from each other. As a result, the outside air and inside air flow through the upper ventilation path 13a and the lower ventilation path 13b via the suction port 13.

The air blowing from the electric blower 22 as described above flows through the upper ventilation path 13a and the lower ventilation path 13b via the suction port 13.

Therefore, the air in the upper ventilation path 13a flows into the cooling heat exchanger 30 as shown by arrow S1 in FIG. 2. The air in the lower ventilation path 13b flows into the cooling heat exchanger 30 as shown by arrow S2 in FIG. 2.

The air in the upper ventilation path 13a and the air in the lower ventilation path 13b flowing in this manner flows into the cooling heat exchanger 30. As a result, the air is cooled by the refrigerant in the cooling heat exchanger 30, and the cold air flows from the cooling heat exchanger 30. A part of the cold air flows into the heating heat exchanger 40. In this way, the part of the cold air blowing from the cooling heat exchanger 30 is heated by the engine cooling water in the heating heat exchanger 40. As a result, warm air flows from the heating heat exchanger 40 toward the opening portions 14, 15, 16. On the other hand, the remaining part of the cold old air from the cooling heat exchanger 30 other than the part flowing into the heating heat exchanger 40 flows toward the opening portions 14, 15, 16 through the bypass passages 35a, 35b.

Therefore, the warm air blowing from the heating heat exchanger 40 and the cold air after passing through the bypass passage 35b are mixed and blown from the foot opening portion 15. The warm air blowing from the heating heat exchanger 40 and the cold air after passing through the bypass passage 35a are mixed and blown from the face opening portion 14. The warm air blowing from the heating heat exchanger 40 and the cold air after passing through the bypass passages 35a, 35b are mixed and blown from the defroster opening portion 16.

At this time, the direct-current motor 22a generates vibrations when the direct-current motor 22a rotates the fan 22b. For example, in the direct-current motor 22a, a rotating force for the rotor is generated when the rotor receives magnetic fields from a stator (i.e., permanent magnets) while the rotor is energized. As a result, the rotating shaft of the direct-current motor 22a rotates the fan 22b. At this time, the motor case functions as a yoke through which magnetic fluxes pass. Because the motor case supports the stator, the motor case expands and contracts due to electromagnetic forces between the rotor and the stator. At this time, the motor case vibrates at a frequency depending on a quantity of poles and a rotation speed of the rotor. The vibrations are transmitted from the direct-current motor 22a to the air conditioning case 11 via the scroll casing 22c and the duct 23.

For example, the opposed wall 18d may resonate with the vibrations transmitted from the direct-current motor 22a to generate what is called a magnetic noise when the partition wall 19 is not provided in the airflow adjustment case portion 17.

On the other hand, according to the present embodiment, the partition wall 19 is provided in the airflow adjustment case portion 17. Therefore, a displacement of a portion of the opposed wall 18d supporting the partition wall 19 is suppressed, and a rigidity of the opposed wall 18d and the airflow adjustment case portion 17 can be increased. As a result, the opposed wall 18d does not resonate with the vibrations transmitted from the direct-current motor 22a.

According to the above-described present embodiment, the air conditioning device 1 for a vehicle includes the electric blower 22 for single layer flow and the single-layer-flow interior air conditioning unit 10 having the air conditioning case 11. The electric blower 22 introduces at least one of the outside air and the inside air and blows out the air. The air conditioning case 11 has the air passages through which the air blowing from the blower unit 20 flows toward the vehicle interior. The electric blower 22 has the direct-current motor 22a, the fan 22b, and the scroll casing 22c. The fan 22b is driven by the direct-current motor 22a to introduce at least one of the outside air and the inside air, and blows out the air. The scroll casing 22c provides the single layer air passage through which the outside air and the inside air blowing from the fan 22b flow without being separated from each other. The cooling heat exchanger 30 is disposed in the air conditioning case 11 and cools the air blowing from the blower unit 20. The partition wall 19 is supported by the airflow adjustment case portion 17. The partition wall 19 is formed to have the plate shape and partitions the inside of the airflow adjustment case portion 17 into the upper ventilation path 13a and the lower ventilation path 13b. The partition wall 19 is in the plate shape and formed along the flow direction of the main flow of the air blowing from the blower unit 20. Therefore, the air blowing from the blower unit 20 is divided to flow through the upper ventilation path 13a and the lower ventilation path 13b.

With the above-described structure, the sidewall 18c and the opposed wall 18d support the partition wall 19. Therefore, the displacement of the portion of the opposed wall 18d supporting the partition wall 19 is suppressed, and the rigidity of the opposed wall 18d can be increased. Furthermore, the partition wall 19 is supported by the sidewall 18c, and the rigidity of the opposed wall 18d can be further increased. Accordingly, the resonance of the opposed wall 18d of the airflow adjustment case portion 17 caused by the vibrations transmitted from the electric blower 22 can be suppressed. As a result, a noise that brings uncomfortable feeling to the occupant can be prevented from being generated by the resonance of the airflow adjustment case portion 17.

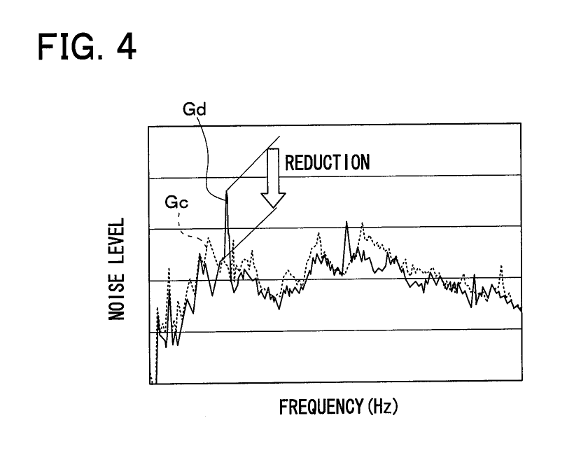

FIGS. 3 and 4 show measured values in verification experiments of the air conditioning device 1 for a vehicle according to the present embodiment. Each of graphs Ga, Gb in FIG. 3 shows a relationship between a vibration acceleration and a frequency of the airflow adjustment case portion 17. Each of graphs Gc, Gd in FIG. 4 shows a relationship between a noise level and a frequency in the vehicle interior. Each of graphs Ga, Gd shows measured values in a verification experiment of an air conditioning device for a vehicle as a comparative example in which the partition wall 19 is not provided in the airflow adjustment case portion 17. Each of graphs Gb, Gc shows the measured value in the verification experiment of the air conditioning device 1 for a vehicle according to the present embodiment in which the partition wall 19 is provided in the airflow adjustment case portion 17.

As can be seen from graphs Ga, Gb in FIG. 3 and graphs Gc, Gd in FIG. 4, a peak of the vibration acceleration of the airflow adjustment case portion 17 and a peak of the noise level are drastically decreased by the partition wall 19.

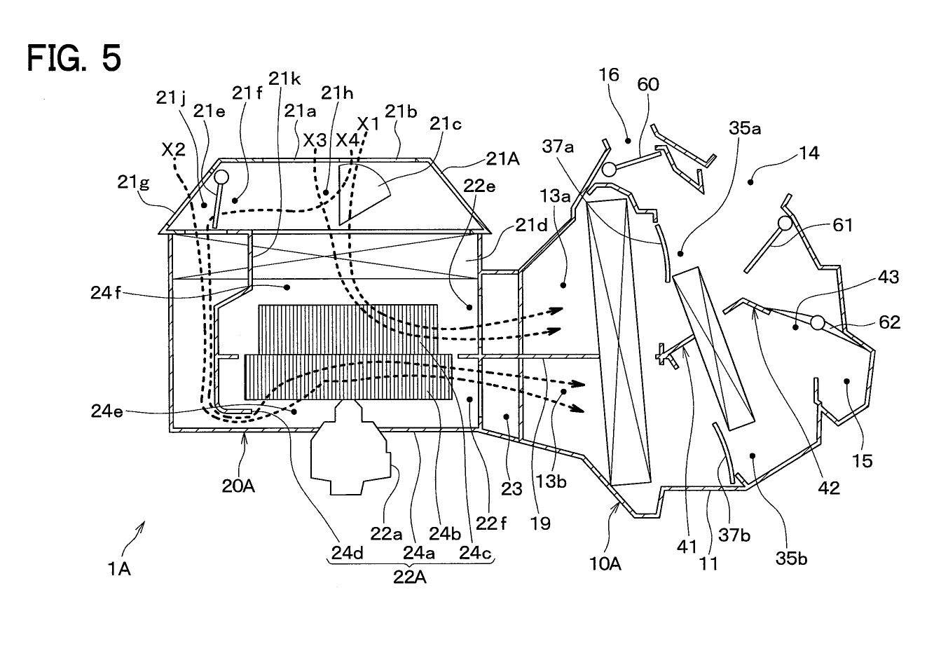

According to the present embodiment, the partition wall 19 is formed to have the plate shape and partitions the inside of the airflow adjustment case portion 17 into the upper ventilation path 13a and the lower ventilation path 13b as described above. Therefore, it is possible to use the airflow adjustment case portion 17 of the present embodiment for a two-layer flow interior air conditioning unit 10A. Consequently, the same airflow adjustment case portion 17 can be used for both the single-layer-flow interior air conditioning unit 10 and the two-layer flow interior air conditioning unit 10A (see FIG. 5).

An outline of the two-layer flow interior air conditioning unit 10A will be described below with reference to FIG. 5.

The two-layer flow interior air conditioning unit 10A includes an air conditioning case 11 having air passages through which two layers of air blowing from a two-layer flow blower unit 20A flow toward the vehicle interior. The air conditioning case 11, the cooling heat exchanger 30, the heating heat exchanger 40, and the mode doors 60, 61, 62 in FIG. 5 are the same as the air conditioning case 11, the cooling heat exchanger 30, the heating heat exchanger 40, and the mode doors 60, 61, 62 in FIG. 1.

The two-layer flow blower unit 20A is configured by an inside/outside air introduction switching box 21A and a two-layer flow electric blower 22A. Air passages 21h, 21j are provided in the inside/outside air introduction switching box 21A. The inside/outside air introduction switching box 21A is provided with the outside air introducing port 21b that introduces air outside the vehicle interior and inside air introducing ports 21a, 21g that introduces air inside the vehicle interior.

The outside air introducing port 21b and the inside air introducing port 21a are provided in the air passage 21h, and the inside air introducing port 21g is provided in the air passage 21j. Inside/outside air switching doors 21c, 21e and the filter 21d are disposed in the inside/outside air introduction switching box 21. The inside/outside air switching door 21c is driven by an actuator such as a servomotor to open one of the outside air introducing port 21b and the inside air introducing port 21a. The inside/outside air switching door 21e is driven by an actuator such as a servomotor to open one of the inside air introducing port 21g and an air passage 21f. The air passage 21f is provided between the air passage 21h and the air passage 21j in the inside/outside air introduction switching box 21A. The filter 21d filters the air introduced from the outside air introducing port 21b and the inside air introducing ports 21a, 21g.

The two-layer flow electric blower 22A includes the direct-current motor 22a, a blower casing 24a, fans 24b, 24c, and the scroll casing 24d. The direct-current motor 22a is supported by the blower casing 24a to drive the fans 24b, 24c rotatably. The fan 24c is driven by the direct-current motor 22a, draws the air introduced from at least one of the outside air introducing port 21b and the inside air introducing port 21a through the filter 21d, and blows out the air. The fan 24b is driven by the direct-current motor 22a, draws the air introduced from the outside air introducing port 21b and the inside air introducing port 21g through the filter 21d, and blows out the air. As each of the fans 24b, 24c, a centrifugal fan that draws the air from one side in an axial direction of a rotating shaft of the direct-current motor 22a and blows the air outward in a radial direction of the rotating shaft is used.

The scroll casing 24d collects the two layers of air blowing from the fans 24b, 24c, and each of blow outlets 22e, 22f blows the two layer of air. At this time, the air blowing from the blow outlet 22e is introduced into the upper ventilation path 13a. The air blowing from the blow outlet 22f is introduced into the lower ventilation path 13b. The blower casing 24a is provided with a separation wall 21k. The separation wall 21k separates an inside of the blower casing 24a into air passages 24e, 24f together with the scroll casing 24d.

For example, when the inside/outside air switching door 21c opens the inside air introducing port 21a, the fan 24c draws the inside air from the inside air introducing port 21a through the filter 21d and the air passage 24f and blows out the air as shown by arrow X3. On the other hand, when the inside/outside air switching door 21c opens the outside air introducing port 21b, the fan 24c draws the outside air from the outside air introducing port 21b through the filter 21d and the air passage 24f and blows out the air as shown by arrow X1. Thus, the air blowing from the fan 24c is blown into the upper ventilation path 13a through the duct 23.

For example, when the inside/outside air switching door 21e opens the inside air introducing port 21g, the fan 24b draws the inside air from the inside air introducing port 21g through the filter 21d and the air passage 24e and blows out the air as shown by arrow X2. On the other hand, when the inside/outside air switching door 21c opens the outside air introducing port 21b and the inside/outside air switching door 21e opens the air passage 21f, the fan 24b draws the outside air from the outside air introducing port 21b through the filter 21d and the air passage 24e and blows out the air as shown by arrow X4. Thus, the air blowing from the fan 24b is blown into the lower ventilation path 13b through the duct 23.

### First Variation of First Embodiment

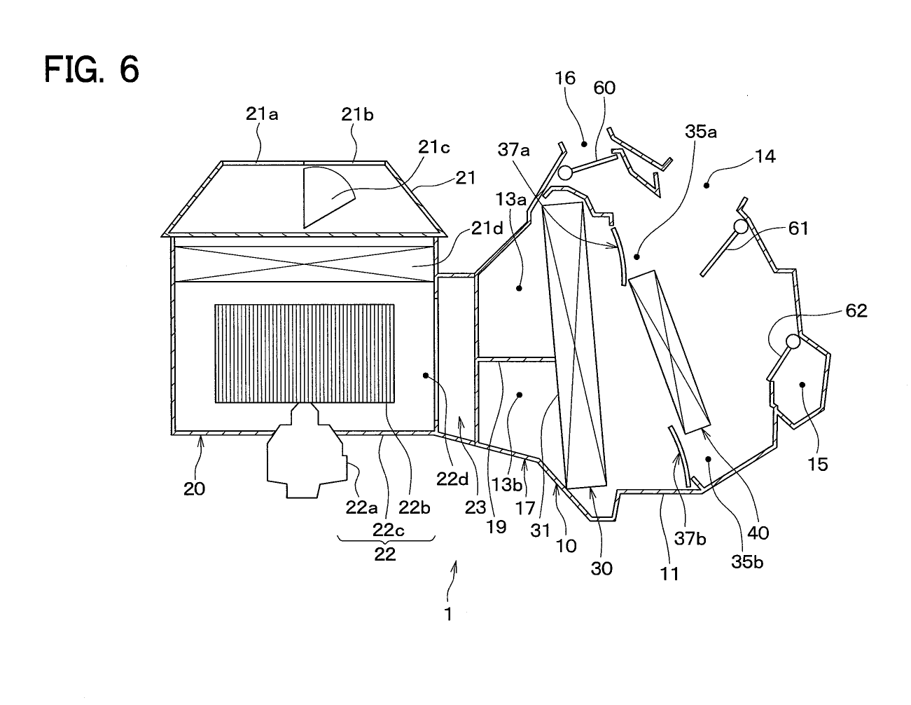

According to the above-described first embodiment, the partition walls 41, 42 are provided on the downstream side of the cooling heat exchanger 30 in the flow direction of air in the air conditioning case 11. However, as shown in FIG. 6, the partition walls 41, 42 may be omitted from the air conditioning case 11.

In this case, the sidewall 18c and the opposed wall 18d support the partition wall 19. In this way, a displacement of a portion of the opposed wall 18d supporting the partition wall 19 is suppressed, and a rigidity of the opposed wall 18d can be increased.

### Second Variation of First Embodiment

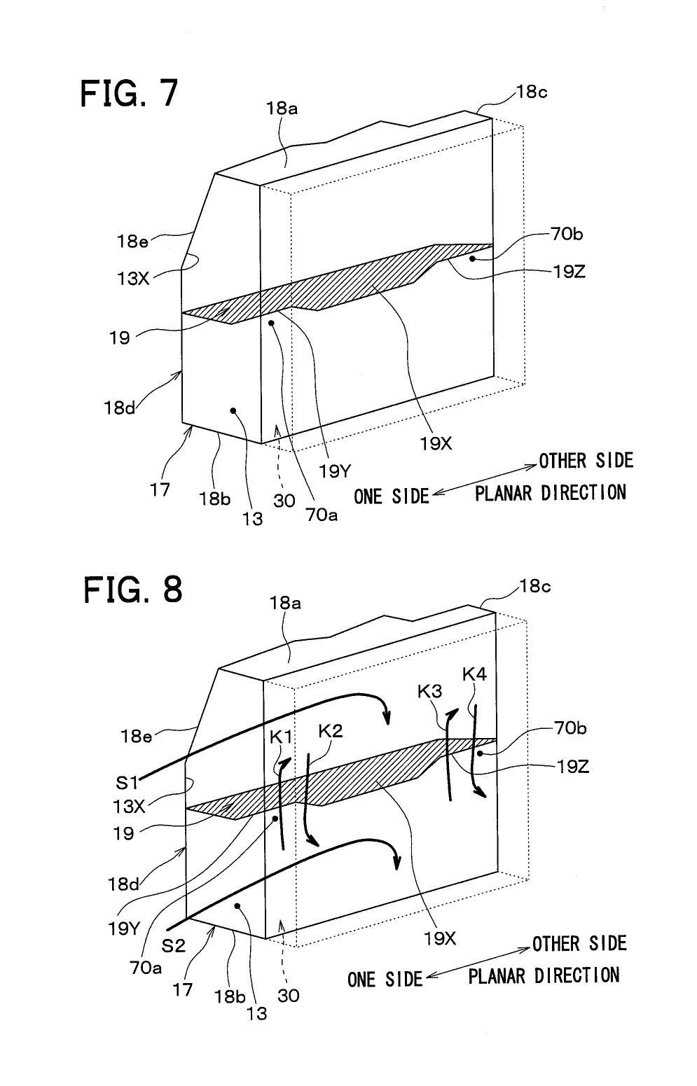

According to the present variation, the airflow adjustment case portion 17 of the above-described first embodiment is provided with air passages 70a, 70b through which air flows between the upper ventilation path 13a and the lower ventilation path 13b as shown in FIG. 7.

The airflow adjustment case portion 17 of the present variation has a protruding portion 19X such that a center portion of the partition wall 19 in the vehicle width direction protrudes toward the cooling heat exchanger 30. In addition, recessed portions 19Y, 19Z are provided in the partition wall 19 on one side and the other side of the protruding portion 19X in the vehicle width direction respectively. Each of the recessed portions 19Y, 19Z is recessed toward an opposite side from the cooling heat exchanger 30. In other words, the recessed portions 19Y, 19Z are recessed away from the cooling heat exchanger 30. Thus, the air passage 70a is formed between the air inflow surface 31 of the cooling heat exchanger 30 and the recessed portion 19Y. The air passage 70b is formed between the air inflow surface 31 of the cooling heat exchanger 30 and the recessed portion 19Z. In other words, the air passage 70a and the air passage 70b are formed on a side of the partition wall 19 adjacent to the air inflow surface 31 of the cooling heat exchanger 30.

When the air flows into the airflow adjustment case portion 17 of the present variation from the blow outlet 22d of the scroll casing 22c via the suction port 13, the air is divided to flow into the upper ventilation path 13a and the lower ventilation path 13b that have the partition wall 19 therebetween. Therefore, the air in the upper ventilation path 13a mainly flows toward the cooling heat exchanger 30 as shown by arrow S1 in FIG. 8. The air in the lower ventilation path 13b mainly flows toward the cooling heat exchanger 30 as shown by arrow S2 in FIG. 8. In addition, the air flows through the air passages 70b, 70c between the upper ventilation path 13a and the lower ventilation path 13b as shown by arrows K1, K2, K3, K4.

According to the present variation described above, the partition wall 19 is formed along a flow direction of a main flow of the air blowing from the blower unit 20 and provided to partition an inside of the air conditioning case into the upper ventilation path 13a and the lower ventilation path 13b. Therefore, a distribution of the air flowing into the cooling heat exchanger 30 can be uniform in a vertical direction in which the upper ventilation path 13a and the lower ventilation path 13b are arranged.

Furthermore, according to the present variation, the protruding portion 19X is formed in the center portion in the vehicle width direction of the partition wall 19. The recessed portions 19Y, 19Z are formed in the partition wall 19 respectively on the one side and the other side of the protruding portion 19X in the vehicle width direction. Therefore, a depth dimension of the center portion of the partition wall 19 in the vehicle width direction is greater than those of the one side and the other side of the partition wall 19 in the vehicle width direction. The depth dimension is a dimension in a direction connecting the opposed wall 18d and the air inflow surface 31 of the cooling heat exchanger 30, in other words, the front-rear direction of the vehicle.

A center portion of the opposed wall 18d in the vehicle width direction has smaller rigidity than one side and the other side of the opposed wall 18d in the vehicle width direction. However, the partition wall 19 having the protruding portion 19X and the recessed portions 19Y, 19Z reinforces the rigidity to equalize the rigidity of the opposed wall 18d of the airflow adjustment case portion 17.

### Second Embodiment

According to the above-described first embodiment, the partition wall 19 is configured by the single plate member. On the other hand, according to the present embodiment, the partition wall 19 is configured by plate members.

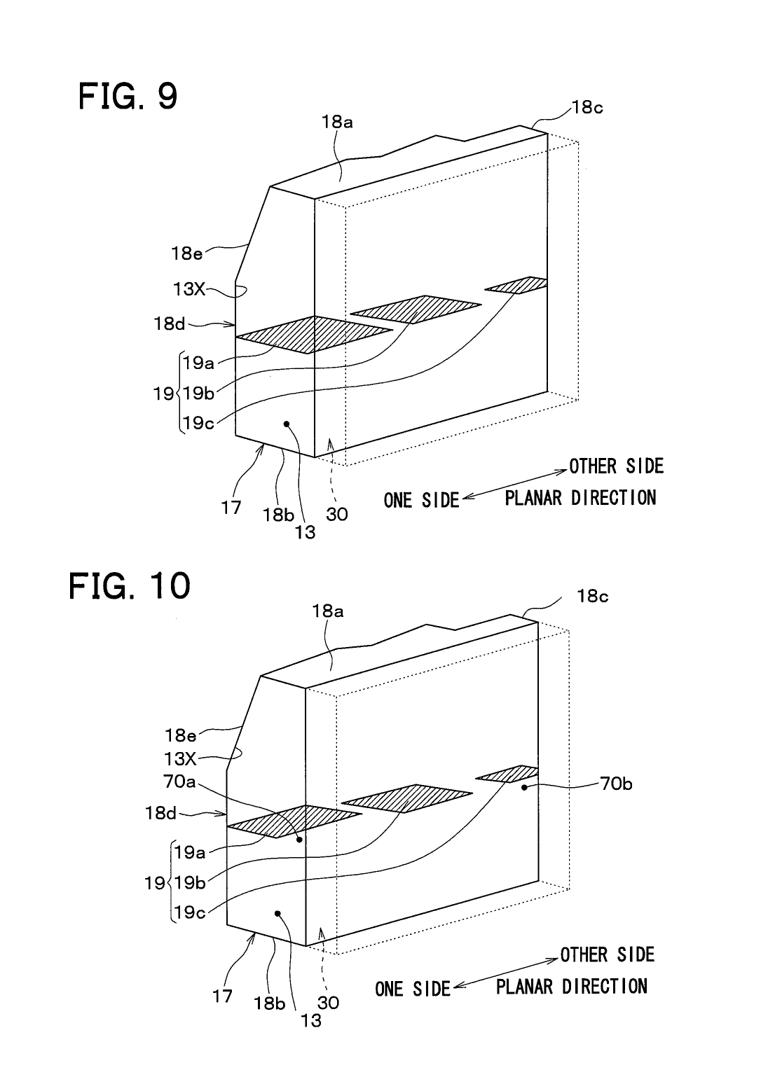

FIG. 9 is a schematic diagram illustrating an inside of an airflow adjustment case portion 17 of the present embodiment. The partition wall 19 is configured by the three plate members 19a, 19b, 19c according to the present embodiment. Each of the plate members 19a, 19b, 19c is formed to have a plate shape extending along the flow direction of the main flow of air blowing from the blower unit 20. The plate members 19a, 19b, 19c are disposed parallel to a horizontal direction and arranged in the horizontal direction.

According to the present embodiment, the plate members 19a, 19b, 19c are disposed to be distanced from each other and arranged along the flow direction of the main flow of the air blowing from the blower unit 20. In other words, the plate members 19a, 19b, 19c are arranged to be distanced from each other and parallel to the flow direction of the main flow.

Therefore, according to the present embodiment, similar to the first embodiment, the partition wall 19 can increase rigidity of the opposed wall 18d of the airflow adjustment case portion 17. As a result, resonance of the airflow adjustment case portion 17 caused by vibrations and transmitted to the airflow adjustment case portion 17 from the electric blower 22 can be suppressed.

The plate members 19a and 19b have a space therebetween according to the present embodiment. The plate members 19b and 19c have a space therebetween. Therefore, the air flows between the upper ventilation path 13a and the lower ventilation path 13b through the space between the plate member 19a and the plate member 19b and through the space between the plate member 19b and the plate member 19c. Therefore, a distribution of the air flowing into the cooling heat exchanger 30 can be further uniform in a vertical direction in which the upper ventilation path 13a and the lower ventilation path 13b are arranged.

The airflow adjustment case portion 17 is not provided with air passages 70a, 70b according to the present embodiment.

### First Variation of Second Embodiment

According to the second embodiment, the airflow adjustment case portion 17 is not provided with the air passages 70a, 70b. However, as shown in FIG. 10, the airflow adjustment case portion 17 may be provided with air passages 70a, 70b.

As shown in FIG. 10, the plate members 19a, 19b, 19c of the present variation are arranged to be distanced from each other in the vehicle width direction. The air passage 70a is formed on a side of the plate member 19a adjacent to the cooling heat exchanger 30, in other words, between the plate member 19a and the cooling heat exchanger 30. The air passage 70b is formed on a side of the plate member 19c adjacent to the cooling heat exchanger 30, in other words, between the plate member 19c and the cooling heat exchanger 30.

According to the present variation, a depth dimension of the plate member 19b is greater than depth dimensions of the plate members 19a, 19c. Therefore, the plate member 19b has a larger size than the plate members 19a, 19c in a plate planar direction. As described above, the depth dimension is a dimension in the direction connecting the opposed wall 18d and the air inflow surface 31 of the cooling heat exchanger 30, in other words, the front-rear direction of the vehicle. The plate planar direction is a planar direction in which the plate members 19a, 19b, 19c extend.

Here, the plate member 19b is supported by a center portion, in the vehicle width direction, of the opposed wall 18d of the airflow adjustment case portion 17. The plate members 19a, 19c are supported by one side and the other side, in the vehicle width direction, of the opposed wall 18d of the airflow adjustment case portion 17. The center portion of the opposed wall 18d in the vehicle width direction has smaller rigidity than the one side and the other side of the opposed wall 18d in the vehicle width direction.

On the other hand, according to the present variation, the plate member 19b has a greater size than the plate members 19a, 19c in the plate planar direction as described above. In this way, a displacement of the center portion in the vehicle width direction of the opposed wall 18d can be further suppressed. As a result, the rigidity of the center portion of the opposed wall 18d in the vehicle width direction can be improved. Therefore, the rigidity of the opposed wall 18d of the airflow adjustment case portion 17 can be equalized.

### Third Embodiment

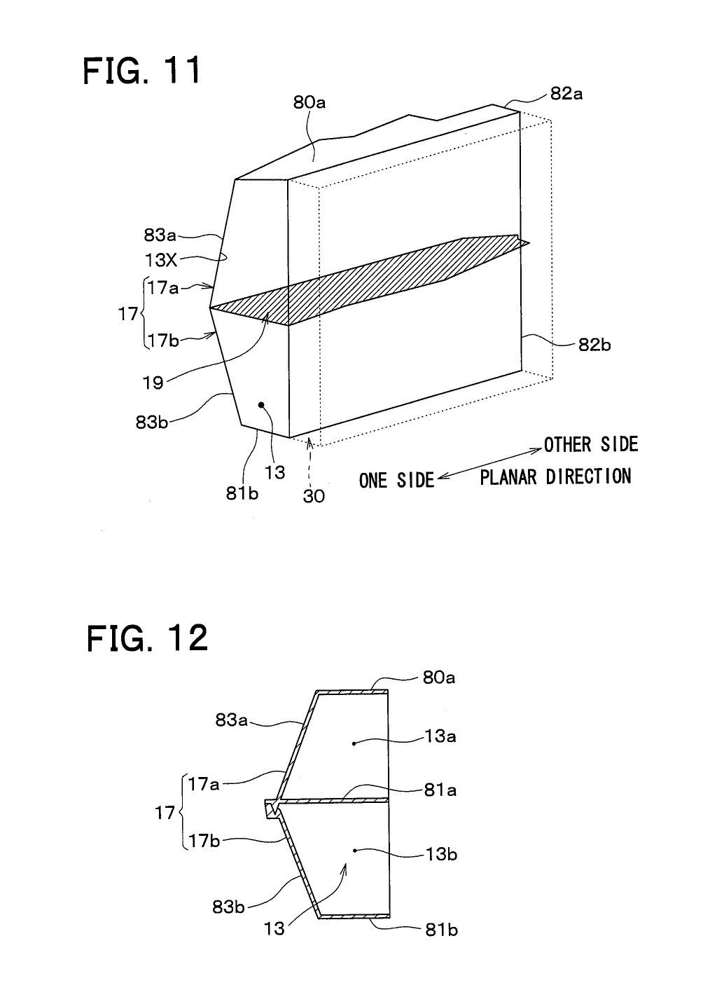

According to the third embodiment, the airflow adjustment case portion 17 of the above-described first embodiment is configured by coupling two divided case portions. FIG. 11 is a schematic diagram illustrating an inside of the airflow adjustment case portion 17 of the present embodiment.

The airflow adjustment case portion 17 of the present embodiment is configured by coupling an upper divided case portion (i.e., a first divided case portion) 17a and a lower divided case portion (i.e., a second divided case portion) 17b. The upper divided case portion 17a is disposed above the lower divided case portion 17b in a vertical direction.

The upper divided case portion 17a configures the upper ventilation path 13a by an upper wall 80a, a lower wall 81a, a sidewall 82a, and an opposed wall 83a. The lower divided case portion 17b configures the lower ventilation path 13b by a lower wall 81b, a sidewall 82b, and an opposed wall 83b.

Here, the upper wall 80a corresponds to the upper wall 18a of the above-described first embodiment, the lower wall 81b corresponds to the lower wall 18b of the first embodiment, and the sidewalls 82a, 82b correspond to the sidewall 18c of the first embodiment. The opposed walls 83a, 83b respectively correspond to the opposed walls 18e, 18d of the first embodiment and are formed in stepped shapes so as to approach the air inflow surface 31 of the cooling heat exchanger 30 as the opposed walls 83a, 83b extend from an upstream side toward a downstream side of a flow of air.

The opposed wall 83a is inclined to be away from the cooling heat exchanger 30 from the upper wall 80a toward the lower wall 81a. The opposed wall 83b is inclined to be away from the cooling heat exchanger 30 from the lower wall 81b toward the upper wall 80a.

Furthermore, the lower wall 81a of the upper divided case portion 17a configures the partition wall 19 and has a plate shape extending along the flow direction of the main flow according to the above-described first embodiment. The lower wall 81a is disposed in the upper divided case portion 17a on a side adjacent to the lower divided case portion 17b. The air passages 70a, 70b are not formed between the lower wall 81a and the air inflow surface 31 of the cooling heat exchanger 30.

According to the present embodiment described above, the lower wall 81a of the upper divided case portion 17a configures the partition wall for separating the upper ventilation path 13a and the lower ventilation path 13b from each other, similar to the above-described first embodiment. Therefore, a rigidity of the opposed walls 83a, 83b can be increased similar to the first embodiment by suppressing a displacement of portions of the opposed walls 83a, 83b supporting the lower wall 81a.

### First Variation of Third Embodiment

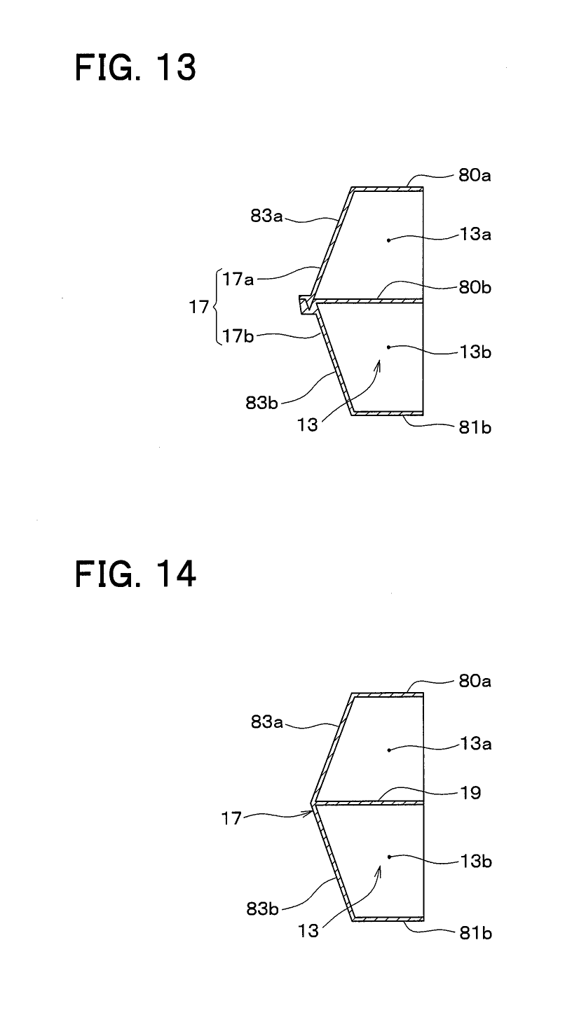

According to the above-described third embodiment, the lower wall 81a of the upper divided case portion 17a configures the partition wall that separates the upper ventilation path 13a and the lower ventilation path 13b from each other. However, as shown in FIG. 13, an upper wall 80b of a lower divided case portion 17b may configure a partition wall that separates the upper ventilation path 13a and the lower ventilation path 13b from each other.

In the lower divided case portion 17b of the present variation, the upper wall 80b, the lower wall 81b, a sidewall 82b, and the opposed wall 83b configure the lower ventilation path 13b. The upper wall 80b is disposed in the lower divided case portion 17b on a side adjacent to an upper divided case portion 17a.

According to the present variation, the opposed wall 83b supports the upper wall 80b. The upper wall 80b configures the partition wall that separates the upper ventilation path 13a and the lower ventilation path 13b from each other. Therefore, a displacement of portions of the opposed walls 83a, 83b supporting the upper wall 80b is suppressed, and a rigidity of the opposed walls 83a, 83b can be increased.

### Second Variation of Third Embodiment

According to the above-described third embodiment and the above-described first variation of the third embodiment, the upper divided case portion 17a and the lower divided case portion 17b are coupled with each other to configure the airflow adjustment case portion 17. However, as shown in FIG. 14, the upper wall 80a, the sidewalls 82a, 82b, the lower wall 81b, the opposed walls 83a, 83b, and the partition wall 19 may be molded integrally and used as the airflow adjustment case portion 17. In other words, the partition wall 19 is integrally molded with the airflow adjustment case portion 17.

### Third Variation of Third Embodiment

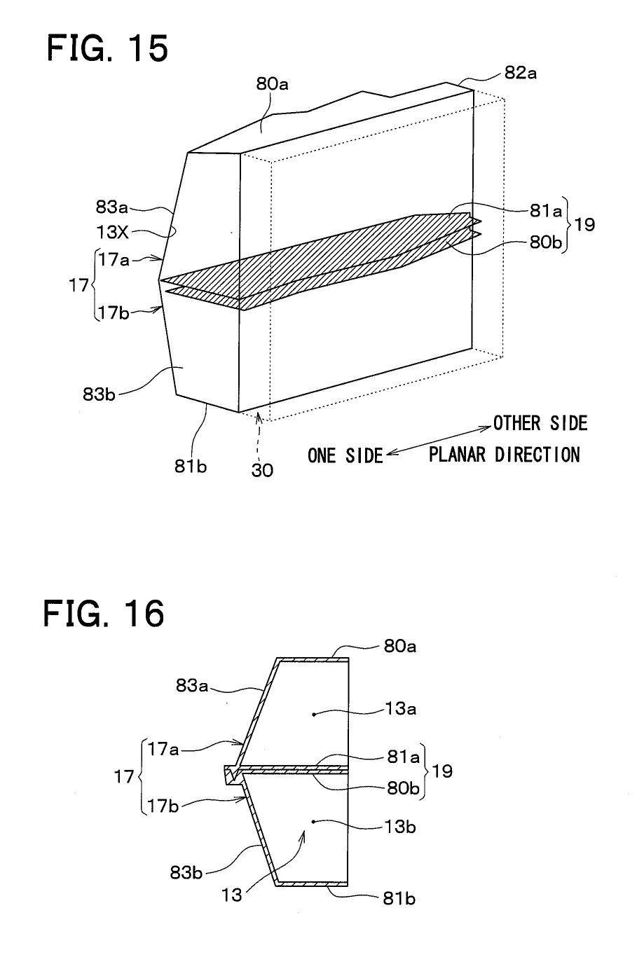

According to the present variation, as shown in FIGS. 15 and 16, the lower wall (i.e., a first wall) 81a of the upper divided case portion 17a and the upper wall (i.e., a second wall) 80b of the lower divided case portion 17b may provide the partition wall 19 that separates the upper ventilation path 13a and the lower ventilation path 13b from each other, as a combination of the third embodiment and the first variation of the third embodiment.

The upper divided case portion 17a provides the upper ventilation path 13a by the upper wall 80a, the lower wall 81a, the sidewall 82a, and the opposed wall 83a. The lower divided case portion 17b provides the lower ventilation path 13b by the upper wall 80b, the lower wall 81b, the sidewall 82b, and the opposed wall 83b. The lower wall 81a of the upper divided case portion 17a is disposed on a side adjacent to the lower divided case portion 17b. The lower wall 81a is supported by the opposed wall 83a. The upper wall 80b of the lower divided case portion 17b is disposed on a side adjacent to the upper divided case portion 17a. The upper wall 80b is supported by the opposed wall 83b.

The lower wall 81a of the upper divided case portion 17a and the upper wall 80b of the lower divided case portion 17b are arranged in the vertical direction to be adjacent to each other in a thickness direction and configure the partition wall 19. In other words, the lower wall 81a and the upper wall 80b are disposed to be adjacent to each other and configure the partition wall 19. The lower wall 81a and the upper wall 80b are formed along a flow direction of a main flow of air.

According to the present variation, the opposed wall 83a supports the lower wall 81a. The opposed wall 83b supports the upper wall 80b. The lower wall 81a and the upper wall 80b configure the partition wall 19. Therefore, a displacement of portions of the opposed walls 83a, 83b supporting the partition wall 19 is suppressed, and a rigidity of the opposed walls 83a, 83b can be increased.

### Fourth Variation of Third Embodiment

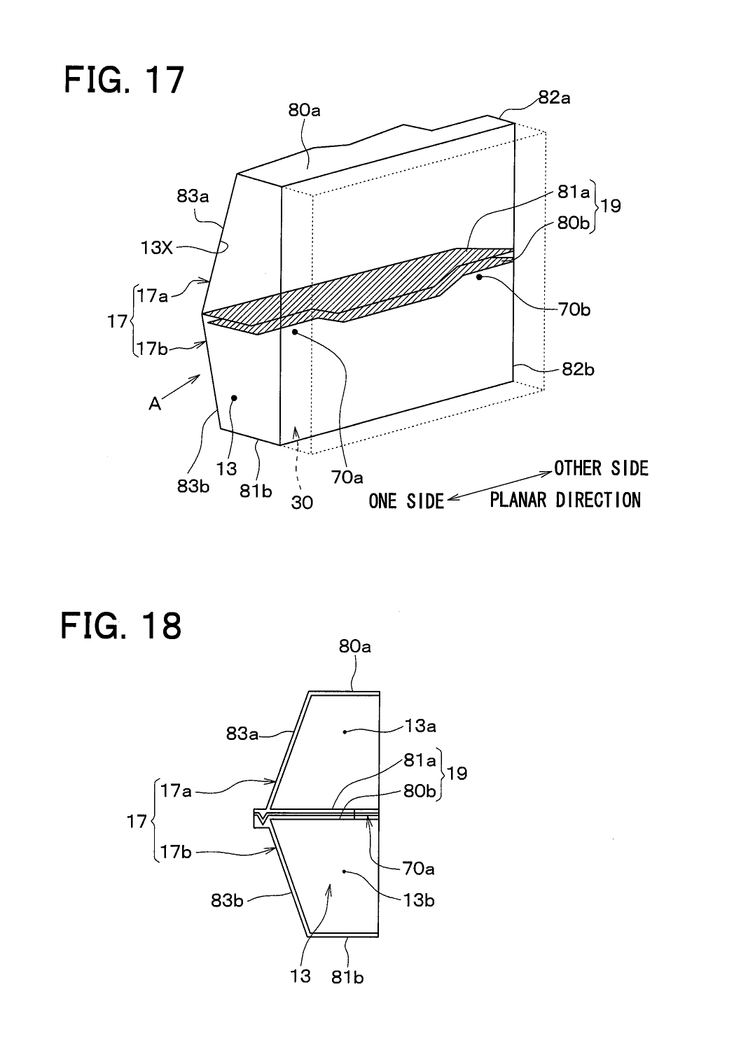

According to a fourth variation, similar to the second variation of the first embodiment, air passages 70a, 70b may be further formed between the air inflow surface 31 of the cooling heat exchanger 30 and each of the lower wall 81a and the upper wall 80 as shown in FIGS. 17 and 18, as compared to the third variation of the third embodiment. In this way, effects similar to those of the second variation of the first embodiment can be obtained.

### Fourth Embodiment

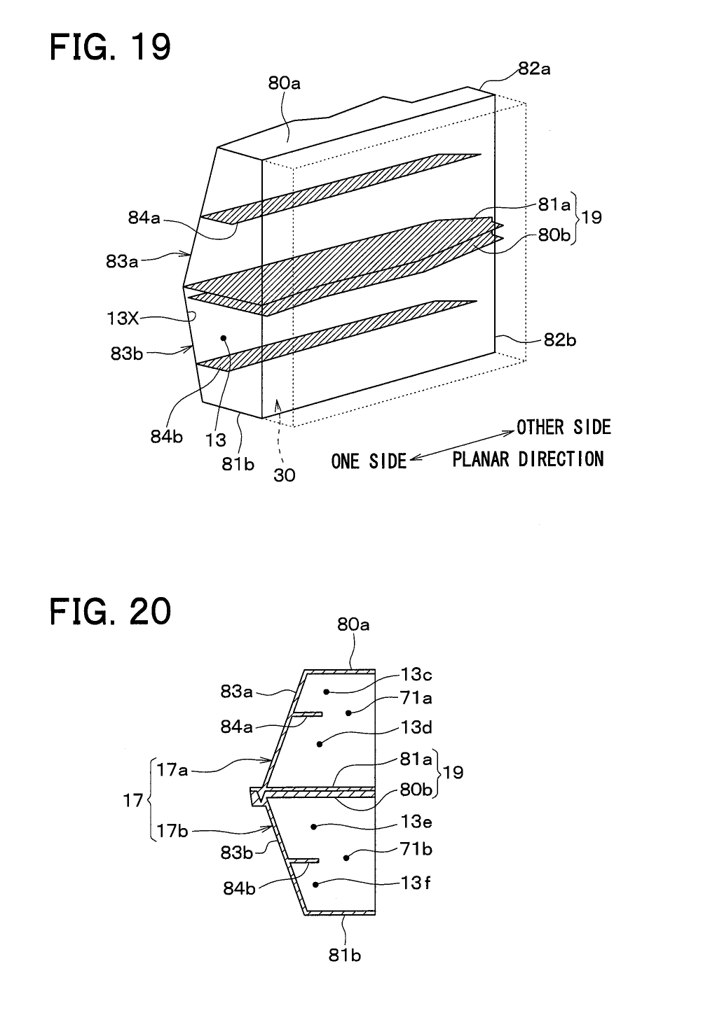

According to the present embodiment, the airflow adjustment case portion 17 further has two partition walls as compared to the above-described third embodiment. FIG. 19 is a schematic diagram illustrating an inside of the airflow adjustment case portion 17 of the present embodiment.

The airflow adjustment case portion 17 of the present embodiment further has partition walls 84a, 84b as compared to the airflow adjustment case portion 17 shown in FIG. 16. The partition wall 84a is disposed in the upper divided case portion 17a. The partition wall 84b is disposed in the lower divided case portion 17b. Each of the partition walls 84a, 84b has a plate shape parallel to a horizontal direction. Therefore, the partition walls 84a, 84b are formed along a flow direction of a main flow of air similarly to the partition wall 19. In other words, the partition walls 19, 84a, 84b are disposed not to overlap with each other when viewed in the flow direction of the main flow of the air blowing from the blower unit 20. Therefore, the partition walls 19, 84a, 84b are arranged in a direction perpendicular to the flow direction of the main flow.

The partition wall 84a partitions an inside of the upper divided case portion 17a into an upper ventilation path 13c and a lower ventilation path 13d. The partition wall 84a is supported by the sidewall 82a and the opposed wall 83a. An air passage 71a (see FIG. 20) is provided between the partition wall 84a and the air inflow surface 31 of the cooling heat exchanger 30. The air passage 71a allows the air to flow between the upper ventilation path 13c and the lower ventilation path 13d in the upper divided case portion 17a.

The partition wall 84b partitions an inside of the lower divided case portion 17b into an upper ventilation path 13e and a lower ventilation path 13f. The partition wall 84b is supported by the sidewall 82b and the opposed wall 83b. Between the partition wall 84b and the air inflow surface 31 of the cooling heat exchanger 30, an air passage 71b (see FIG. 20) is provided. The air passage 71b allows the air to flow between the upper ventilation path 13e and the lower ventilation path 13f in the lower divided case portion 17b.

According to the above-described present embodiment, the opposed wall 83a of the upper divided case portion 17a supports the partition wall 84a. Therefore, a displacement of a portion of the opposed wall 83a supporting the partition wall 84a is suppressed, and a rigidity of the opposed wall 83a can be increased. In addition, the partition wall 84a is supported by the sidewall 82a, and thereby the rigidity of the opposed wall 83a can be further increased.

The opposed wall 83b of the lower divided case portion 17b supports the partition wall 84b. Therefore, a displacement of a portion of the opposed wall 83b supporting the partition wall 84b is suppressed, and a rigidity of the opposed wall 83b can be increased. In addition, the partition wall 84b is supported by the sidewall 82b.

As a result, the rigidity of the opposed walls 83a, 83b of the airflow adjustment case portion 17 can be further increased. Therefore, resonance of the opposed walls 83a, 83b caused by vibrations and transmitted from the electric blower 22 can be suppressed further reliably.

The partition walls 84a, 84b of the present embodiment have the plate shapes extending along the flow direction of the main flow of the air. The air passage 71a is provided between the partition wall 84a and the cooling heat exchanger 30. Therefore, the air can flow between the upper ventilation path 13c and the lower ventilation path 13d through the air passage 71a in the upper divided case portion 17a.

Moreover, the air passage 71b is provided between the partition wall 84b and the cooling heat exchanger 30. Therefore, the air can flow between the upper ventilation path 13e and the lower ventilation path 13f through the air passage 71b in the lower divided case portion 17b.

As a result, a distribution of the air flowing into the cooling heat exchanger 30 can be uniform in a vertical direction.

### First Variation of Fourth Embodiment

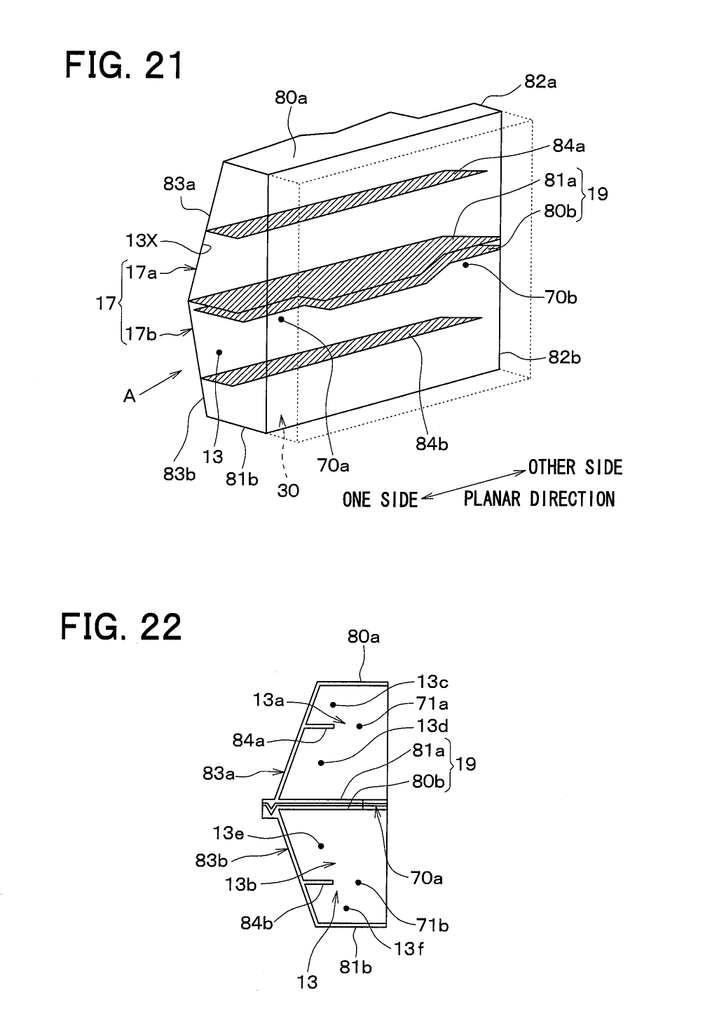

According to the present variation, as shown in FIGS. 21 and 22, air passages 70a, 70b through which air flows between the upper ventilation path 13a and the lower ventilation path 13b may be further provided as compared to the above-described fourth embodiment. In this case, similar effects to those of the second variation of the first embodiment can be obtained.

### Other Embodiments

(1) According to the first to fourth embodiments and the variations thereof, the partition wall 19 is disposed parallel to the horizontal direction. However the partition wall 19 may be disposed to be perpendicular to a horizontal direction.

(2) According to the fourth embodiment and the first variation of the fourth embodiment, the partition walls 19, 84a, 84b are disposed parallel to the horizontal direction. However, the partition walls 19, 84a, 84b may be disposed to be perpendicular to a horizontal direction.

(3) According to the first to fourth embodiments and the variations thereof, the centrifugal fan is used as the fan 22b of the present disclosure. However, another type of fans other than the centrifugal fan may be used as the fan 22b of the present disclosure.

(4) According to the first to fourth embodiments and the variations thereof, the direct-current motor 22a is used as the motor for driving the fan 22b of the present disclosure. However, another type of motors other than the direct-current motor 22a may be used as the motor for driving the fan 22b of the present disclosure.

(5) According to the first to fourth embodiments and the variations thereof, the blowing case of the present disclosure is configured by the scroll casing 22c and the duct 23. However, the blowing case of the present disclosure may be configured by the scroll casing 22c of the scroll casing 22c and the duct 23. In other words, the scroll casing 22c may be directly connected to the airflow adjustment case portion 17.

(6) According to the first to fourth embodiments and the variations thereof, the partition walls (19, 84a, 84b) of the present disclosure is supported by the opposed wall 18d of the airflow adjustment case portion 17. However, the partition walls of the present disclosure may be supported by any one of the upper wall 18a, the lower wall 18b, and the sidewall 18c of the airflow adjustment case portion 17.

(7) According to the variation of the second embodiment, the plate member 19b has a larger size than the plate members 19a, 19c in the plate planar direction, and thereby increasing the rigidity of the center portion of the opposed wall 18d in the vehicle width direction. However, the plate member 19b may be have a greater thickness than the plate members 19a, 19c to increase rigidity of the center portion of the opposed wall 18d in the vehicle width direction.

The present disclosure is not limited to the above-described embodiments and can be modified within the scope of the present disclosure as defined by the appended claims. The above-described first through fourth embodiments are not unrelated to each other and can be combined with each other except for a case where the combination is clearly improper. Even when a feature such as a material forming a member, a shape of a member, or a positional relation of members, it is to be understood that such feature is not limited to a specific material, shape, positional relation, or the like except for a case of being explicitly specified to be necessary and a case of being considered to be absolutely necessary in principle.

What is claimed is:

1. An air conditioning device for a vehicle comprising:
an electric blower for a single layer flow, the electric blower having (i) an electric motor, (ii) a fan that is driven by the electric motor and introduces at least one of air outside a vehicle interior and air inside the vehicle interior, and (iii) a blowing case that forms a single layer air passage in which the air outside the vehicle interior and the air inside the vehicle interior blowing from the fan flow without being separated from each other;
an air conditioning case through which air blowing from the blowing case flows toward the vehicle interior;
a cooling heat exchanger that is disposed in the air conditioning case and cools the air blowing from the blowing case;
a partition wall that is disposed on an upstream side of the cooling heat exchanger in a flow direction of the air in the air conditioning case and partitions an inside of the air conditioning case into a first ventilation path and a second ventilation path; and
an air passage through which the air blowing from the blowing case flows between the first ventilation path and the second ventilation path, wherein
the air blowing from the blowing case flows through the first ventilation path and the second ventilation path,
the blowing case is connected to a portion of the air conditioning case located on the upstream side of the cooling heat exchanger in the flow direction of the air, and
the partition wall is supported by the portion of the air conditioning case located on the upstream side of the cooling heat exchanger in the flow direction of the air, and formed along a flow direction of a main flow of the air blowing from the blowing case.

2. The air conditioning device for a vehicle according to claim 1, wherein
the partition wall is formed integrally with the portion of the air conditioning case located on the upstream side of the cooling heat exchanger in the flow direction of the air.

3. The air conditioning device for a vehicle according to claim 1, wherein
the portion of the air conditioning case located on the upstream side of the cooling heat exchanger in the flow direction of the air is configured by coupling a first divided case portion forming the first ventilation path and a second divided case portion forming the second ventilation path.

4. The air conditioning device for a vehicle according to claim 3, wherein
a first wall is provided in the first divided case portion on a side adjacent to the second divided case portion,
a second wall is provided in the second divided case portion on a side adjacent to the first divided case portion, and
the first and second walls are disposed to be adjacent to each other and configure the partition wall.

5. The air conditioning device for a vehicle according to claim 3, wherein
a first wall forming the partition wall is provided in the first divided case portion on a side adjacent to the second divided case portion.

6. The air conditioning device for a vehicle according to claim 3, wherein
a second wall forming the partition wall is provided in the second divided case portion on a side adjacent to the first divided case portion.

7. The air conditioning device for a vehicle according to claim 3, wherein
the first divided case portion is disposed above the second divided case portion.

8. The air conditioning device for a vehicle according to claim 1, wherein
a plurality of the partition walls are provided, and
the plurality of partition walls are disposed not to overlap with each other when viewed in the flow direction of the air.

9. The air conditioning device for a vehicle according to claim 8, wherein
the plurality of partition walls are arranged in a vertical direction.

10. The air conditioning device for a vehicle according to claim 1, wherein
the partition wall is configured by a plurality of plate members, and each of the plurality of plate members is formed to have a plate shape extending along the flow direction of the main flow, and
the plurality of plate members are disposed to be distanced from each other and arranged in the flow direction of the air.

11. The air conditioning device for a vehicle according to claim 10, wherein
a plate member included in the plurality of the plate members and supported by a portion of the air conditioning case having low rigidity has a larger size in a plate planar direction than a plate member included in the plurality of the plate members and supported by a portion of the air conditioning case having high rigidity.

12. The air conditioning device for a vehicle according to claim 1, wherein
a suction port into which the air blowing from the blowing case flows is formed in the portion of the air conditioning case located on the upstream side of the cooling heat exchanger in the flow direction of the air,
the cooling heat exchanger has an air inflow surface through which the air flows, and the suction port is positioned in the air inflow surface on one side in a planar direction of an air inflow surface, and
the portion of the air conditioning case located on the upstream side of the cooling heat exchanger in the flow direction of the air includes:
an opposed wall that faces the air inflow surface and supports the partition wall;
a sidewall that is formed on an opposite side of the suction port with respect to the air inflow surface;
an upper wall that is disposed above the opposed wall and the sidewall and configures the first ventilation path together with the opposed wall, the sidewall and the partition wall; and
a lower wall that is disposed below the opposed wall and the sidewall and configures the second ventilation path together with the opposed wall, the sidewall and the partition wall.

13. The air conditioning device for a vehicle according to claim 12, wherein
the sidewall supports the partition wall together with the opposed wall.

14. (canceled)

15. The air conditioning device for a vehicle according to claim 1, wherein
the air passage is formed in the partition wall on a side adjacent to the cooling heat exchanger.
